(19) United States
(12) Patent Application Publication
(10) Pub. No.: US 2021/0357237 A1
(43) Pub. Date: Nov. 18, 2021

(54) Method and System for Auto-Grading of Structured Documents

(71) Applicant: MassiveU, Inc., Naples, FL (US)

(72) Inventors: Angelo BIASI, Naples, FL (US); Collin STOWELL, Naples, FL (US)

(21) Appl. No.: 17/319,846

(22) Filed: May 13, 2021

Related U.S. Application Data
(60) Provisional application No. 63/024,178, filed on May 13, 2020.

(51) Int. Cl. G06F 9/451; G06F 40/166; G06F 40/106

(52) U.S. Cl. CPC G06F 9/453; G06F 40/106; G06F 40/166

(57) ABSTRACT

A method for providing computer-based instruction concerning use of a computer program to a learner comprises: providing instructions to the learner to edit a structured document using the computer program; receiving the document as edited by the learner; normalizing the edited document; comparing the normalized document to a grading template; and providing feedback to the learner. The step of normalizing the document may further comprise the steps of: removing irrelevant patterns; resolving document references; and applying custom pattern normalizers. The step of comparing the normalized document to a grading template may further comprise comparing the normalized document to a plurality of grading templates. The grading templates may include a plurality of elements corresponding to the structure of the document.

### RELATED APPLICATIONS

This application claims the benefit of U.S. Application Ser. No. 63/024,178, filed May 13, 2020, which is incorporated by reference.

### BACKGROUND

A need exists for persons skilled at using computer programs such as word processing, spreadsheet and database programs, among other programs and applications. However, individual instruction and evaluation of progress is expensive and, in time of global pandemic, not always possible. Automated instruction programs have been developed, but it is believed that known auto-grading systems are manually written to check for specific features. As such, they limit flexibility in creating a lesson plan and do not lend themselves well to complex or rarer specific use cases.

### SUMMARY

A method for providing computer-based instruction to a learner concerning use of a computer program comprises: providing instructions to the learner to edit a structured document using the computer program; receiving the document as edited by the learner; normalizing the edited document; comparing the normalized document to a grading template; and providing feedback to the learner. The step of normalizing the document may further comprise the steps of: removing irrelevant patterns; resolving document references; and applying custom pattern normalizers.

The step of comparing the normalized document to a grading template may further comprise comparing the normalized document to a plurality of grading templates. The grading templates may include a plurality of elements corresponding to the structure of the document.

The structured document may comprise an XML structured document. In some embodiments, the document comprises an Open Office XML document.

The method may further comprise the step of providing a grading template authoring tool to a course author.

### BRIEF DESCRIPTION OF THE DRAWINGS

FIG. 1 illustrates an information flow according to an aspect of the present invention.

FIG. 2 illustrates a learner computer in relation to a server according to another aspect of the present invention.

FIGS. 3-6 illustrate examples of a computer display presented to a learner according to another aspect of the present invention.

FIG. 7A illustrates a first example of a node structure of a learner document.

FIG. 7B illustrates a second example of a node structure of a learner document.

FIG. 8 illustrates composition of a grading pattern according to another aspect of the present invention.

### DESCRIPTION

A computer-based system is provided for providing instruction and evaluating learning and competency in the use of computer programs and applications. This instruction and grading system advantageously allows for grading of almost any instruction regarding the use of the computer program as long as the document has evidence of a corresponding action being taken in response to the instruction. This is possible in part because the system of the present invention allows the author to craft grading patterns rather than relying on hard-coded feature-based graders. Another advantage of the system is the normalization of learner documents prior to application of a grading pattern. This improves accuracy of the auto-grading.

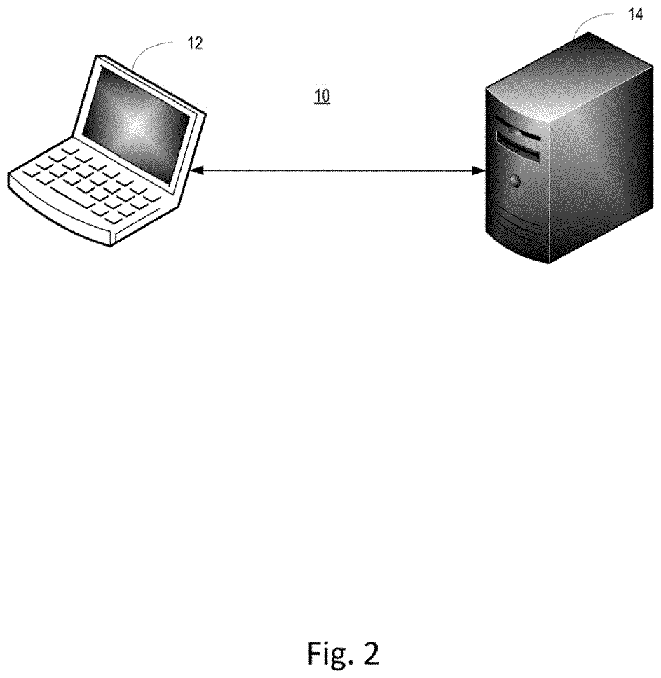

Referring to FIG. 2, the system 10 may comprise a client-server architecture, with a learner's computer 12 comprising a client device and a server 14 hosting instructional lessons and grading templates. The learner's computer 12 may comprise a conventional computer, tablet or mobile device. Alternatively, the system 10 may be implemented locally on the learner's computer.

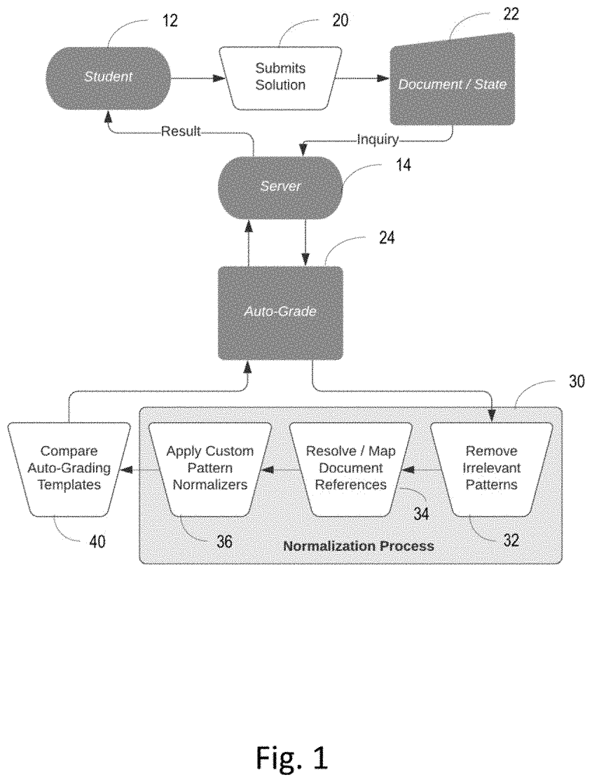

An overview of the information flow is illustrated in FIG. 1. As set forth in more detail below in the following examples, a student submits a solution after instruction, which is auto-graded and a result returned. The example provided herein is in the context of a Microsoft Office readiness & training application. Microsoft Office applications store documents in the Office Open XML format. However, the invention is not limited to Office Open XML applications and documents, and is readily extendable to other structured document formats, such as Open Document for Office Applications (ODF).

Office Open XML is a zipped, XML-based file format developed by Microsoft for representing spreadsheets, charts, presentations and word processing documents. The format has been standardized by the ISO and IEC as ISO/IEC 29500. The present invention leverages this structured format for automatic grading of documents.

In one example, an introductory lesson in Microsoft Word for learning enhancing and formatting text is provided. An example of a display 50 of the client application presenting a document in a starting point state to a learner is illustrated in FIG. 2. A word processing window 52 is presented with starting text. The starting text is unformatted and the paragraph style is “Normal.” Instructional text is provided in an instructor tester window 54 to the right of the document.

Prior to editing, the XML, representation of the body of the document may, for example, contain the following XML text shown in Table 1:

```
TABLE 1
  <w:body>
    <w:p w14:paraId=“1F9318CD” w14:textId=“2494947C”
    w:rsidR=“005A2AE1” w:rsidRDefault=“002A36CC”
    w:rsidP=“00523AA3”>
      <w:r><w:t>Top three formulas everyone should know
      (according to me)</w:t></w:r>
    </w:p>
    <w:p w14:paraId=“7311173C” w14:textId=“65142EB4”
    w:rsidR=“002A36CC” w:rsidRDefault=“002A36CC”
    w:rsidP=“00523AA3”>
      <w:r><w:t>1. Area of a square, where one side is a: Area =
      a2</w:t></w:r>
    </w:p>
    <w:p w14:paraId=“36FB857C” w14:textId=“1D326D1E”
    w:rsidR=“002A36CC” w:rsidRDefault=“002A36CC”
    w:rsidP=“00523AA3”>
      <w:r><w:t>2. Area of a circle, where radius is r: Area =
      πr2</w:t></w:r></w:p>
    <w:p w14:paraId=“10481A66” w14:textId=“069F52DD”
    w:rsidR=“002A36CC” w:rsidRPr=“00EE62A4”
    w:rsidRDefault=“002A36CC” w:rsidP=“00523AA3”>
      <w:r><w:t>3. Standard line: y = mx +b</w:t></w:r>
    </w:p>
    <w:sectPr w:rsidR=“002A36CC”
    w:rsidRPr=“00EE62A4”><w:pgSz w:w=“12240”
    w:h=“15840”/><w:pgMar w:top=“1440” w:right=“1440”
    w:bottom=“1440” w:left=“1440” w:header=“720” w:footer=“720”
    w:gutter=“0”/><w:cols w:space=“720”/><w:docGrid
    w:linePitch=“360”/></w:sectPr>
</w:body>
```

This text may be found, for example, in a file named “document.xml” in the zipped Word document. In the above, w:p refers to a paragraph and w:r refers to a text run. The actual values of paragraph ID (paraId) and text ID (textId) are not material to the present discussion.

In the starting state, neither the text runs nor the paragraphs have any special formatting. In the instruction text window 54, the learner is instructed 56 to change the font size of “Top three formulas everyone should know” to 20 point. After the learner makes the change to the document, the system intakes the modified document and parses the document XML file for the text string to be modified. If correctly changed, the document XML file may contain the following XML text shown in Table 2:

TABLE 2

```
<w:body>
  <w:p w14:paraId=“1F9318CD” w14:textId=“2494947C”
  w:rsidR=“005A2AE1” w:rsidRDefault=“002A36CC”
  w:rsidP=“00523AA3”>
    <w:r w:rsidRPr=“002D7468”><w:rPr><w:sz
    w:val=“40”/><w:szCs w:val=“40”/></w:rPr><w:t>Top three
    formulas everyone should know</w:t></w:r>
    <w:r><w:t xml:space=“preserve”> (according to
    me)</w:t></w:r>
  </w:p>
  <w:p w14:paraId=“7311173C”w14:textId=“65142EB4”
  w:rsidR=“002A36CC” w:rsidRDefault=“002A36CC”
  w:rsidP=“00523AA3”>
    <w:r><w:t>1. Area of a square, where one side is a: Area =
    a2</w:t></w:r>
  </w:p>
  <w:p w14:paraId=“36FB857C” w14:textId=“1D326D1E”
  w:rsidR=“002A36CC” w:rsidRDefault=“002A36CC”
  w:rsidP=“00523AA3”>
    <w:r><w:t>2. Area of a circle, where radius is r: Area =
    πr2</w:t></w:r></w:p>
  <w:p w14:paraId=“10481A66” w14:textId=“069F52DD”
  w:rsidR=“002A36CC” w:rsidRPr=“00EE62A4”
  w:rsidRDefault=“002A36CC” w:rsidP=“00523AA3”>
    <w:r><w:t>3. Standard line: y = mx +b</w:t></w:r>
  </w:p>
  <w:sectPr w:rsidR=“002A36CC”
  w:rsidRPr=“00EE62A4”><w:pgSz w:w=“12240”
  w:h=“15840”/><w:pgMar w:top=“1440” w:right=“1440”
  w:bottom=“1440” w:left=“1440” w:header=“720” w:footer=“720”
  w:gutter=“0”/><w:cols w:space=“720”/><w:docGrid
  w:linePitch=“360”/></w:sectPr>
</w:body>
```

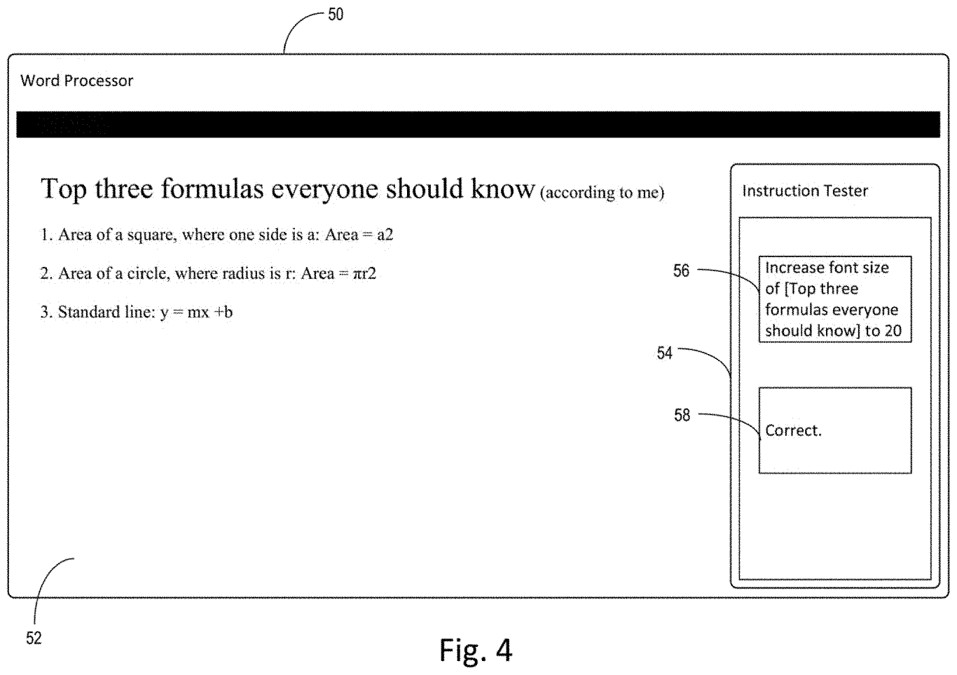

The word run for “Top three formulas everyone should know” now includes w:rPr (run properties) and sz (font size) values. These properties and corresponding values show that the learner has correctly changed the font size to 20 (Open Office XML specification uses half point measurement units, so a sz value of 40 represents a font size of 20). FIG. 4 illustrates a representation of a computer display where the learner has changed the font to 20, and the system provides in-lesson, real time positive feedback 58.

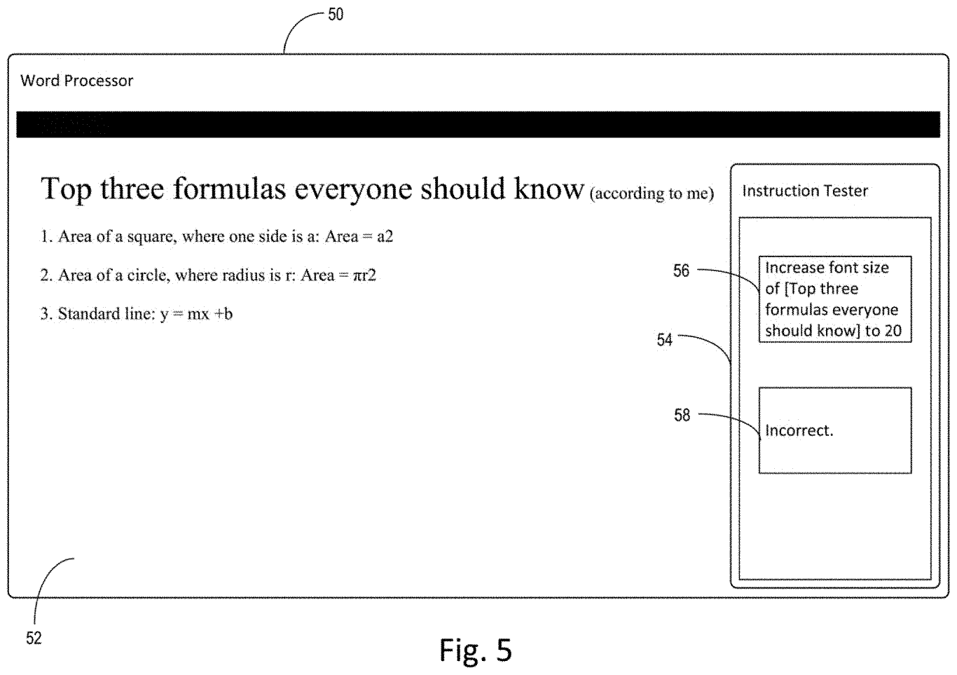

FIG. 5 shows a illustrates a representation of a computer display where the learner has changed the font to 24. The relevant portion of the document XML, would be as follows as shown in Table 3:

TABLE 3

<w:r w:rsidRPr=“002D7468”><w:rPr><w:sz
w:val=“48”/><w:szCs w:val=“48”/></w:rPr><w:t>Top three
formulas everyone should know</w:t></w:r>

The system recognizes the sz value of 48 as incorrect and provides in-lesson, real time feedback to the learner. The learner may then correct any mistakes, improving the learning process.

The above concepts are readily applied to additional document properties. For example, the learner may also be instructed to change the “2” to a superscript in the formula for the area of a square, to italicize “r” and to change the “2” to a superscript in the formula for the area of a circle, and change the paragraph style for each paragraph to “Body Text Single.” If correctly changed, the document.xml file may contain the following XML, text in Table 4:

TABLE 4

```
<w:body>
  <w:p w14:paraId=“1F9318CD” w14:textId=“2494947C”
  w:rsidR=“005A2AE1” w:rsidRDefault=“002A36CC”
  w:rsidP=“00523AA3”>
    <w:pPr><w:pStyle w:val=“BodyTextSingle”/></w:pPr>
    <w:r w:rsidRPr=“002D7468”><w:rPr><w:sz
    w:val=“40”/><w:szCs w:val=“40”/></w:rPr><w:t>Top three
    formulas everyone should know</w:t></w:r>
    <w:r><w:t xml:space=“preserve”> (according to
    me)</w:t></w:r>
  </w:p>
  <w:p w14:paraId=“7311173C” w14:textId=“65142EB4”
  w:rsidR=“002A36CC” w:rsidRDefault=“002A36CC”
  w:rsidP=“00523AA3”>
    <w:pPr><w:pStyle w:val=“BodyTextSingle”/></w:pPr>
    <w:r><w:t>1. Area of a square, where one side is a: Area =
    a</w:t></w:r>
    <w:r w:rsidRPr=“002D7468”> <w:rPr><w:vertAlign
    w:val=“superscript”/></w:rPr><w:t>2</w:t></w:r>
  </w:p>
  <w:p w14:paraId=“36FB857C” w14:textId=“1D326D1E”
  w:rsidR=“002A36CC” w:rsidRDefault=“002A36CC”
  w:rsidP=“00523AA3”>
    <w:pPr><w:pStyle w:val=“BodyTextSingle”/></w:pPr>
    <w:r><w:t>2. Area of a circle, where radius is r: Area =
    π</w:t></w:r>
    <w:r w:rsidRPr=“002D7468”><w:rPr><w:i/></w:rPr>
    <w:t>r</w:t></w:r>
  </w:p>
  <w:r w:rsidRPr=“002D7468”><w:rPr><w:vertAlign
  w:val=“superscript”/></w:rPr><w:t>2</w:t></w:r>
  <w:p w14:paraId=“10481A66” w14:textId=“069F52DD”
  w:rsidR=“002A36CC” w:rsidRPr=“00EE62A4”
  w:rsidRDefault=“002A36CC” w:rsidP=“00523AA3”>
    <w:pPr><w:pStyle w:val=“BodyTextSingle”/></w:pPr>
    <w:r><w:t>3. Standard line: y = mx +b</w:t></w:r>
  </w:p>
  <w:sectPr w:rsidR=“002A36CC”
  w:rsidRPr=“00EE62A4”><w:pgSz w:w=“12240”
  w:h=“15840”/><w:pgMar w:top=“1440”w:right=“1440”
  w:bottom=“1440” w:left=“1440” w:header=“720” w:footer=“720”
  w:gutter=“0”/><w:cols w:space=“720”/><w:docGrid
  w:linePitch=“360”/></w:sectPr>
</w:body>
```

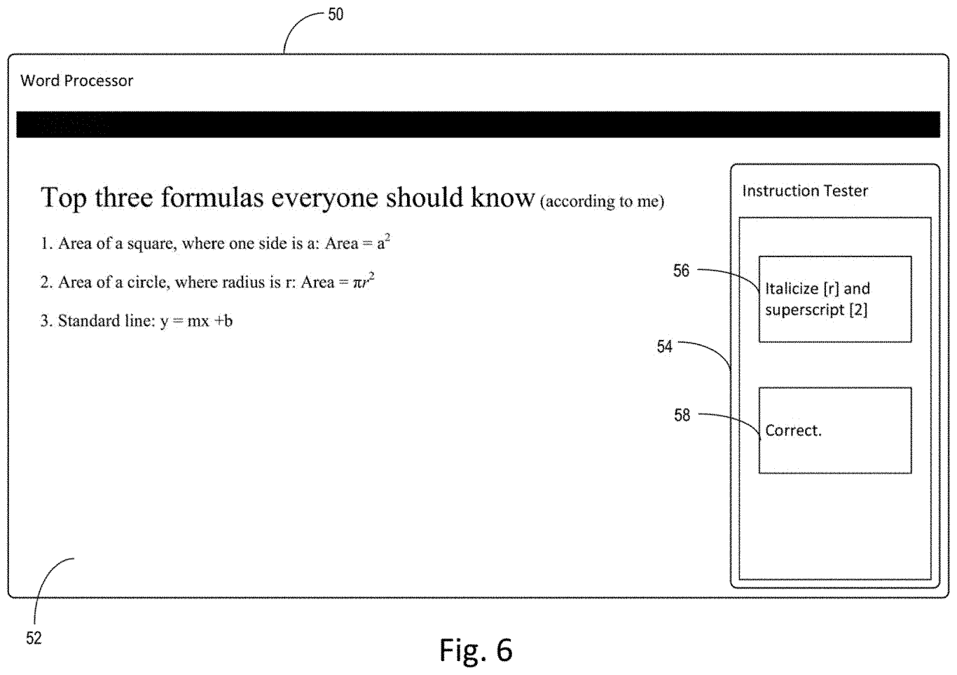

Similarly to the example above with respect to font size, the system is configured to identify relevant document properties and determine corresponding property values, recognize the application of paragraph styles and other instructed formatting, and provides feedback, as shown in FIG. 6. For example, learners may be instructed to italicize certain letters of words and apply superscript/subscript formatting.

While the above example is described with reference to the document.xml file, additional files may be relevant to a lesson. For example, the MS Word zip file also includes files named footnotes.xml, endnotes.xml, styles.xml, etcetera, each of which may be graded as relevant to a particular lesson. Additionally, the present invention is not limited to word processing documents. Spreadsheet documents, presentation documents, and other documents may also use a zipped XML structure and have their own corresponding XML documents within the zipped file. For example, a Microsoft PowerPoint document may include an XML file for each slide in a presentation. The present invention is adaptable to each of these various document structures.

Referring to FIG. 1, once the learner (or their client application) has submitted 20 a document 22 to be graded to the server 14, the server 14 submits the document to an auto-grading process 24. Prior to application of a Grading Template 40 (described below), a normalization process 30 is applied to the document. The normalization process is performed to create a more predictable and consistent basis from which to grade. Typically, learners may use different versions of the software, which may create different document structures for what visually may appear to be the same document. This “black box” effect, when not normalized, may create unpredictable behavior for auto-grading applications. For most document types, the normalization process removing irrelevant patterns 32, resolving/mapping document references 34, and applying custom pattern normalizers 36.

Most file formats contain fragments or patterns of data that are irrelevant for auto-grading/objective differentiation. For example, Microsoft Office document markup may contain numerous sets of revision identifiers and bookmarks which fragment the document and can create unpredictable document structure. These irrelevant patterns are identified and removed 32 in the first phase of document normalization.

Certain file formats, particularly markup-based documents, may contain internal references to other files within the document structure. This can be particularly problematic when attempting to auto-grade as these internal files may have different file names, and use different relationships to establish presence within the core document hierarchy. The resolve/map document references phase 34 of the normalization process maps these references, and stitches the referenced data into the core document. This process is referred to as reference resolving, as the references are located and mapped into their appropriate place within the core document structure.

Typically, there are custom patterns within learner documents that need to have custom (re)formatting applied in order to ensure a more predictable structure. The apply custom pattern normalizers phase 36 of normalization involves passing the document through a series of custom normalizer functions which will recursively search the document for particular patterns. If and when these patterns have been located, custom formatting logic is applied to that particular area of the document to increase document consistency.

The goal of the grading process is to end with a binary result—either correct or incorrect. To arrive at this result, the normalized learner document/state is compared to one or many grading templates. If at least one grading template is considered to match the document provided by the learner, then the result is considered correct. These templates define a set of patterns, with each pattern containing specific rules as to where the certain nodes and attributes may or may not be located as well as what they may, may not, or may partially contain. These are termed “Locational patterns” for location-based conditions and “Containment patterns” for existence/occurrence conditions. These two terms apply mostly to markup-based auto grading applications, e.g. XML, HTML, etc.

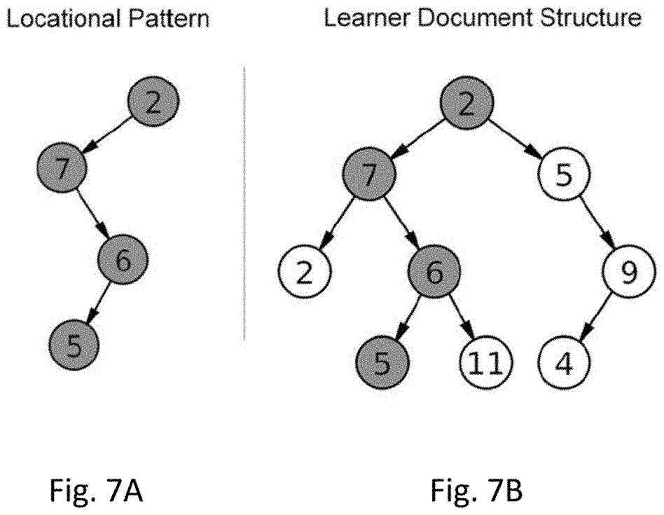

Referring to FIG. 7A, locational patterns are used to evaluate the positioning of a relevant object or property within the learner's document. Within a tree-based document structure, this is represented as a list of linked nodes. Each node may also contain special properties as to where it's location may be, including: (a) must be found exactly where defined, (b) must be found anywhere as a direct descendant of the parent node, (c) must be found anywhere within the document tree—in no particular area. The learner's document is recursively traversed and searched for all of the patterns specified within the template. If one or more patterns cannot be found, the template match is considered a failure.

Containment patterns are used within tree structured documents to specify existence rules within a particular node. Confirming the existence, nonexistence, or number of occurrences of particular attributes or child nodes is important to the auto-grade process. Referring to FIG. 7B, the auto-grading system may support the following containment patterns for the following elements within a tree-based structure. For standard nodes, the supported patterns include a number of occurrences of defined children nodes and a number of occurrences of node attributes. For node attributes, supported patterns include an existence or non-existence of the attribute and the following operators for attribute value: contains, lacks, greater than, less than, equal to, not equal to. For text nodes, the same operator values may be used.

The auto-grading process enables the author of a lesson to configure one or more of these rules for every standard node, attribute, and text node within a markup-based document. Using a combination of rules allows for maximum flexibility and an increased tolerance for document variance.

As applied to instruction example given above, the system may be configured to verify that the student has changed the font size of the text “Top 10 Formulas Everyone Should Know” to 20 pt. The system uses one or more grading templates to identify the following in descending order:
1. First paragraph on the page
2. A text run within that paragraph containing the text “Top 10 Formulas Everyone Should Know”
3. Run properties containing the font size of 20.

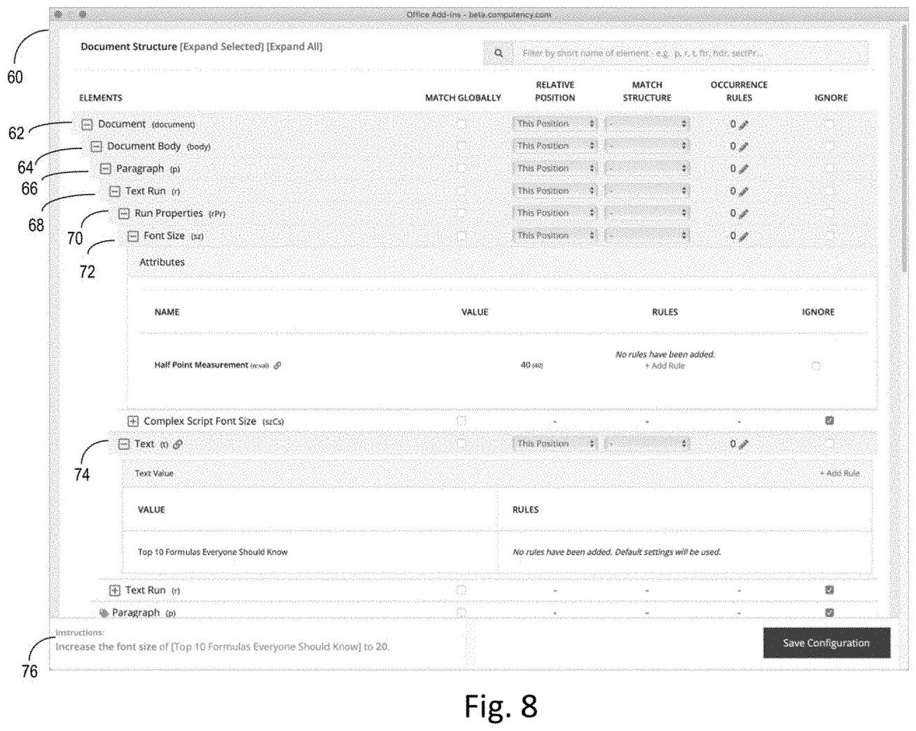

Referring to FIG. 8, the system 10 includes a course authoring tool. Using this tool, administrators have the ability to create auto-grading templates. Each instruction within a lesson should have one or more grading templates. The reason for supporting multiple templates per instruction is to accommodate the (potentially) multiple documents that pedagogically could be considered correct.

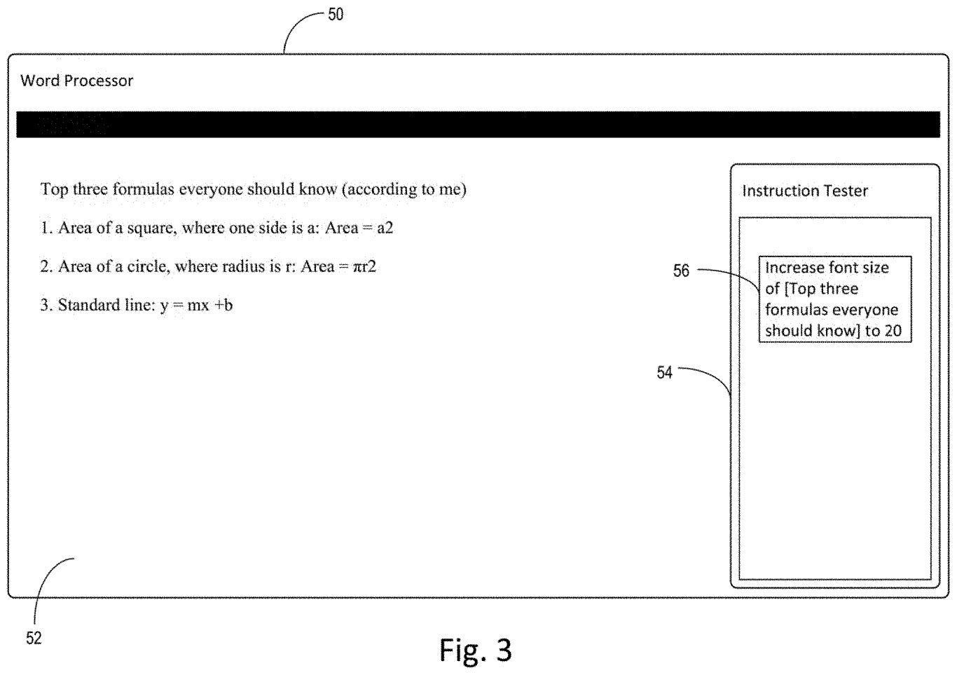

For the example illustrated in FIGS. 3 through 5, the grading template is created to identify a single text run that is located in the first paragraph of the document. That text run must contain the text “Top 10 Formulas Everyone Should Know” and should contain a font size run property setting the font size to 20 (half point measurement of 40). FIG. 8 illustrates an auto-grading template 60 that validates font size 20 being applied to the first text run.

The grading template 60 includes a number of nested windows corresponding to the document structure. In the example of FIG. 8, the template includes a document element 62 and nested within the document element 62 is a document body element 64. Within the document body element 64 is one or more paragraph elements 66. Within the paragraph element, one or more text run elements 68 may be added.

Each text run element 68 may be assigned run properties 70. In the illustrated example, the run properties 68 include a font size property 72 and a text value property 74. A field 76 for instructional text is also provided. In the illustrated example, because the instructional text is: “Increase the font size of [Top 10 Formulas Everyone Should Know] to 20”, other elements of the document unrelated to this instruction may be ignored by the grading template by checking an “ignore” box.

In the example of FIG. 4, the learner correctly set the font size to 20. Based on the grading template, the system confirms that the appropriate text run in the first paragraph font size of 20 (40 half points). In the example of FIG. 5, the learner has incorrectly set the font size to 24 instead of the expected 20. The server returns an error message indicating that it was able to find matches for the paragraph, text run, and text run content, but was unable to find a match for the font size value (48 vs expected 40).

Errors not relevant to the current learning task do not generate an error message. For example, if the learner correctly sets the font size to 20, but commits a typo elsewhere in the paragraph, pedagogically, this instruction is still considered correct and the auto-grading template takes partial matching into consideration for this use case.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method for providing computer-based instruction concerning use of a computer program to a learner, comprising:
providing instructions to the learner to edit a structured document using the computer program;
receiving the document as edited by the learner;
normalizing the edited document;
comparing the normalized document to a grading template; and
providing feedback to the learner.

2. The method of claim 1, wherein the step of normalizing the document further comprises the steps of:
removing irrelevant patterns;
resolving document references; and
applying custom pattern normalizers.

3. The method of claim 1, wherein the step of comparing the normalized document to a grading template further comprises comparing the normalized document to a plurality of grading templates.

4. The method of claim 1, wherein the document comprises an XML structured document.

5. The method of claim 1, wherein the document comprises an Open Office XML document.

6. The method of claim 1, wherein the grading template includes a plurality of elements corresponding to the structure of the document.

7. The method of claim 1, further comprising the step of providing a grading template authoring tool to a course author.
